(19) United States
(12) Patent Application Publication
(10) Pub. No.: US 2008/0129858 A1
(43) Pub. Date: Jun. 5, 2008

(54) AUTO-FOCUS IMAGING SYSTEM

(75) Inventor: SHENG-JUNG YU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/847,281

(22) Filed: Aug. 29, 2007

(30) Foreign Application Priority Data
Dec. 1, 2006 (CN) 200610157221.5

(51) Int. Cl. H04N 5/232; G03B 13/34

(52) U.S. Cl. 348/345; 396/133; 348/E05.042

(57) ABSTRACT

An exemplary auto-focus imaging system includes a holder, an image sensor, a barrel unit, a stepper motor, and a belt. The image sensor is disposed in the holder. The barrel unit is coupled to the holder, in a threaded manner. The belt is looped around the barrel unit and the stepper motor. The stepper motor is disposed on the holder and configured for driving the barrel unit to move relative to the image sensor using belt drive.

### BACKGROUND

1. Technical Field

The present invention relates to the optical imaging field and, particularly, to an auto-focus imaging system.

2. Description of Related Art

Auto-focus techniques have been widely employed in various imaging systems, including still camera systems and video camera systems. At present, there are basically two main auto-focus methods: one is an active focus (i.e., distance metering) method and the other is a passive focus (i.e., focus detection) method. The passive focus method mainly employs a charge-coupled device (CCD) and works by evaluating the amount of contrast or the phase difference in a scene. The active focus method usually uses an infrared light or ultrasound emitter and a corresponding receiver in a triangular surveying system, the data thus generated being converted by a microprocessor (e.g., a well-known digital signal processor) into information about distance and thereby enabling the automatic focusing by an auto-focus imaging system.

Generally, a digital auto-focus camera system includes an optical imaging assembly, an image sensor, a control unit, and an actuator. The optical imaging assembly usually includes a movable lens assembly. The image sensor can be a CCD or a complementary metal oxide semiconductor device (CMOS). The control unit can be, for example, a digital signal processor or an image signal processor. The actuator commonly includes a stepper motor and a drive circuitry. The drive circuitry, regulated by the control unit, can drive the stepper motor to perform a rotational movement. In order to carry out the position adjustment of the movable lens assembly in an automatic focusing process, a gear assembly has been employed in the lens movement system to transform the rotational movement of the stepper motor into a linear movement. However, the existence of the gear assembly, generally, renders the lens positioning system unduly bulky. Furthermore, the occurrence of backlash/recoil in the gear assembly will usually result in a degraded focusing accuracy.

It is therefore desirable to find a new auto-focus imaging system, which can overcome the above mentioned problems.

### SUMMARY

An exemplary auto-focus imaging system includes a holder, an image sensor, a barrel unit, a stepper motor, and a belt. The image sensor is disposed in the holder. The barrel unit is coupled to the holder, in a threaded manner. The belt is looped around the barrel unit and the stepper motor. The stepper motor is disposed on the holder and configured for driving the barrel unit to move relative to the image sensor using belt drive.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of an auto-focus imaging system according to a preferred embodiment; and

FIG. 2 is a schematic, side cross-sectional view of the auto-focus imaging system of FIG. 1 taken along the line II-II thereof.

### DETAILED DESCRIPTION OF THE EMBODIMENTS

Embodiments will now be described in detail below with reference to the drawings.

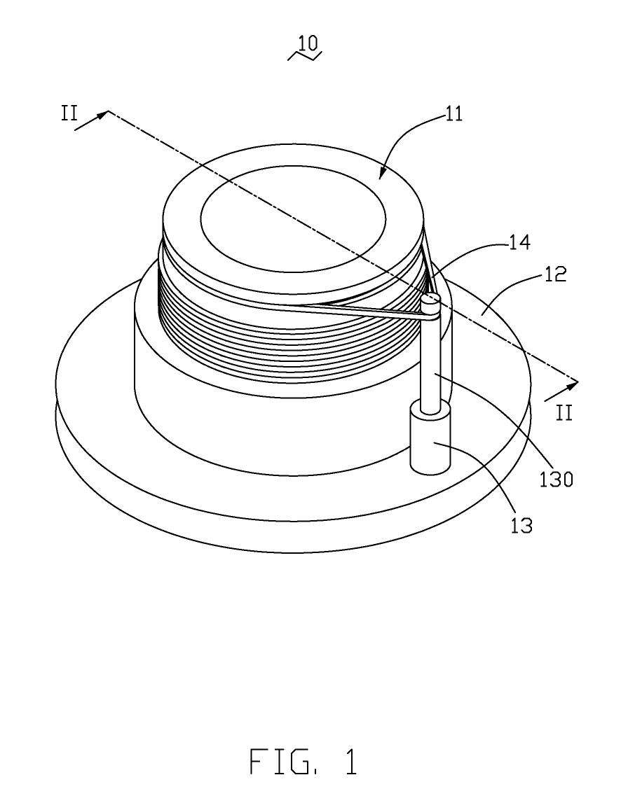

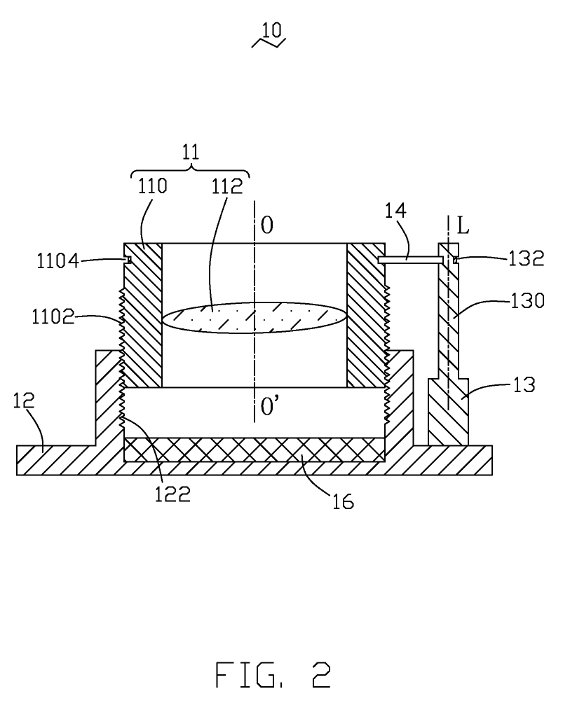

Referring to FIGS. 1 and 2, an auto-focus imaging system 10 of a preferred embodiment is shown. The auto-focus imaging system 10 includes a barrel unit 11, a holder 12, a stepper motor 13, and an image sensor 16. The stepper motor 13 is positioned on the holder 12 and the image sensor 16 is disposed in the holder 12. The barrel unit 11 is coupled to the holder 12, in a threaded manner, so that a distance between the barrel unit 11 and the image sensor 16 can be adjusted by rotating the barrel unit 11. The image sensor 16 can be a CCD or a CMOS.

The barrel unit 11 includes a barrel 110 and at least one lens 112 in the barrel 110. The barrel unit 11 has an optical axis OO′. A first groove 1104 can be defined in the barrel 110.

The stepper motor 13 includes a motor shaft 130 having an axis (not labeled) parallel to the optical axis OO′ of the barrel unit 11. The motor shaft 130 can be cylindrical. A second groove 132 can be defined in the motor shaft 130.

A belt 14 is looped around the barrel unit 11 and the motor shaft 130. The belt 14 is configured for driving the barrel unit 11 to move along the optical axis OO′ relative to the image sensor 16. Part of the belt 14 is received in the first groove 1104 and another part of the belt 14 is received in the second groove 132. The belt 14 can be made of nylon or leather.

When a first voltage is applied to the stepper motor 13, the motor shaft 130 spins clockwise. Then the stepper motor 13 drives the barrel unit 11 to rotate clockwise using the belt 14 because of a first friction between the motor shaft 130 and the belt 14 and a second friction between the belt 14 and the barrel unit 11. Thus, the barrel unit 11 is moved towards the image sensor 16 along the optical axis OO′ to achieve an appropriate focus. Likewise, when a second voltage is applied to the stepper motor 13, the motor shaft 130 spins anticlockwise and drives the barrel unit 11 to rotate anticlockwise. In this way, the barrel unit 11 is moved away from the image sensor 16 along the optical axis OO′ to achieve an appropriate focus.

In the above present embodiment, the stepper motor 13 is disposed beside the barrel unit 11 and, accordingly, a thickness of the auto-focus imaging system 10 is reduced. Furthermore, the auto-focus imaging system 10 is free of complicated components (e.g., a gear assembly) and, therefore, has a more compact structure.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An auto-focus imaging system comprising:
a holder;
an image sensor disposed in the holder;
a barrel unit threadedly coupled to the holder;
a stepper motor disposed on the holder and configured for driving the barrel unit to move relative to the image sensor using belt drive; and
a belt looped around the barrel unit and the stepper motor.

2. The auto-focus imaging system as claimed in claim 1, wherein the barrel unit has a groove defined thereon receiving part of the belt therein.

3. The auto-focus imaging system as claimed in claim 1, wherein the stepper motor comprises a motor shaft, the motor shaft having a groove defined thereon receiving part of the belt therein.

4. The auto-focus imaging system as claimed in claim 1, wherein a material of the belt is selected from the group consisting of nylon and leather.

5. The auto-focus imaging system as claimed in claim 1, wherein the barrel unit comprises a barrel and at least one lens disposed in the barrel.

6. The auto-focus imaging system as claimed in claim 5, wherein the at least one lens defines an optical axis, and the stepper motor comprises a motor shaft with a lengthwise direction being parallel to the optical axis.

7. The auto-focus imaging system as claimed in claim 6, wherein the barrel has a groove defined thereon receiving part of the belt therein.

8. The auto-focus imaging system as claimed in claim 1, wherein the image sensor is a charge-coupled device or a complementary metal oxide semiconductor device.

9. An auto-focus imaging system comprising:
a holder;
an image sensor arranged in the holder;
at least one lens defining an optical axis;
a barrel receiving the at least one lens therein, the barrel being in threaded engagement with the holder, thus being threadedly movable along the optical axis with respect to the holder;
a stepper motor having a motor shaft juxtaposed with the barrel and configured for driving the barrel to move relative to the image sensor; and
an endless belt looped around the barrel and the motor shaft of the stepper motor.
